(19) United States
(12) Patent Application Publication
(10) Pub. No.: US 2025/0286207 A1
(43) Pub. Date: Sep. 11, 2025

(54) THERMAL RUNAWAY PROTECTION SYSTEM FOR A BATTERY PACK

(71) Applicant: GM Global Technology Operations LLC, Detroit, MI (US)

(72) Inventors: Michael Maes, Berkley, MI (US); Anthony Michael Coppola, Rochester Hills, MI (US); Grant Bruce Zuccaro, Ray Twp, MI (US); Anshul Kaushal, Lake Orion, MI (US); Mohammad Hamza Kirmani, Troy, MI (US); Andrew Yonka, Sterling Heights, MI (US); Evan David Griffith, Pleasant Ridge, MI (US); Matthew D. Kimball, Clarkston, MI (US); Kyle James Clare, Brighton, MI (US)

(21) Appl. No.: 18/601,375

(22) Filed: Mar. 11, 2024

(51) Int. Cl. H01M 50/358; H01M 10/48

(52) U.S. Cl. CPC H01M 50/358; H01M 10/482; H01M 2220/20

(57) ABSTRACT

According to several aspects, a thermal runaway ducting system for a battery pack having one or more thermal runaway protection (TRP) trays is provided. The thermal runaway ducting system may include one or more flexible hoses in fluid communication with the one or more TRP trays. The thermal runaway ducting system further may include a sensor manifold in fluid communication with the one or more flexible hoses and a battery pack exit vent.

### INTRODUCTION

The present disclosure relates to systems for thermal runaway protection (TRP) for battery packs, and more particularly, to thermal runaway ducting systems for battery packs having one or more thermal runaway protection (TRP) trays.

To increase performance, manufacturability, and reliability of vehicle battery packs, vehicle battery packs may be equipped with thermal runaway protection (TRP) systems which are designed to mitigate the buildup of fluid (e.g., gas) released from battery cells during a thermal runaway event. Current TRP systems may include one or more ducts or passageways to direct fluid towards an exit vent of the battery pack. TRP systems further may include insulating material for the purpose of preventing thermal runaway of one battery cell from propagating to adjacent battery cells. In some examples, the insulating material includes an expanding potting compound. However, the one or more ducts or passageways of current TRP systems may not be fluid-tight, allowing the expanding potting compound to intrude into the one or more ducts or passageways, reducing a volume of the passageways and thus impeding fluid flow.

Thus, while TRP systems achieve their intended purpose, there is a need for a new and improved system for thermal runaway protection (TRP) for battery packs.

### SUMMARY

According to several aspects, a thermal runaway ducting system for a battery pack having one or more thermal runaway protection (TRP) trays is provided. The thermal runaway ducting system may include one or more flexible hoses in fluid communication with the one or more TRP trays. The thermal runaway ducting system further may include a sensor manifold in fluid communication with the one or more flexible hoses and a battery pack exit vent.

In another aspect of the present disclosure, each of the one or more flexible hoses further includes a first quick connect fitting, a second quick connect fitting, and a flexible tube in fluid communication with the first quick connect fitting and the second quick connect fitting. The flexible tube provides fluid communication between the first quick connect fitting and the second quick connect fitting.

In another aspect of the present disclosure, the one or more flexible hoses further includes a first flexible hose. The first quick connect fitting of the first flexible hose is in fluid communication with a first TRP tray. The second quick connect fitting of the first flexible hose is in fluid communication with the sensor manifold. The one or more flexible hoses further includes a second flexible hose. The first quick connect fitting of the second flexible hose is in fluid communication with a second TRP tray. The second quick connect fitting of the second flexible hose is in fluid communication with the sensor manifold.

In another aspect of the present disclosure, the sensor manifold further includes a first inlet port in fluid communication with the second quick connect fitting of the first flexible hose. The sensor manifold further includes a second inlet port in fluid communication with the second quick connect fitting of the second flexible hose.

In another aspect of the present disclosure, the one or more flexible hoses further includes a first flexible hose. The first quick connect fitting of the first flexible hose is in fluid communication with a first TRP tray. The second quick connect fitting of the first flexible hose is in fluid communication with a second TRP tray. The one or more flexible hoses further includes a second flexible hose. The first quick connect fitting of the second flexible hose is in fluid communication with the second TRP tray. The second quick connect fitting of the second flexible hose is in fluid communication with the sensor manifold.

In another aspect of the present disclosure, the sensor manifold further includes a first inlet port in fluid communication with the second quick connect fitting of the second flexible hose.

In another aspect of the present disclosure, the one or more flexible hoses further includes further includes a tee-joint hose in fluid communication with a first TRP tray and a second TRP tray. The one or more flexible hoses further includes further includes a first flexible hose. The first quick connect fitting of the first flexible hose is in fluid communication with the tee-joint hose. The second quick connect fitting of the first flexible hose is in fluid communication with the sensor manifold.

In another aspect of the present disclosure, the sensor manifold further includes a first inlet port in fluid communication with the second quick connect fitting of the first flexible hose.

In another aspect of the present disclosure, the sensor manifold further includes one or more inlet ports in fluid communication with one of the one or more flexible hoses. The sensor manifold further includes a sensor port configured to allow measurement of a fluid within the sensor manifold using a sensor. The sensor manifold further includes an outlet port in fluid communication with the battery pack exit vent.

In another aspect of the present disclosure, the thermal runaway ducting system further includes a battery pack casting. The battery pack exit vent is integral with the battery pack casting. The outlet port of the sensor manifold is in fluid communication with the battery pack exit vent using a press-in-place seal.

In another aspect of the present disclosure, the thermal runaway ducting system further includes a battery pack casting. The battery pack exit vent is integral with the battery pack casting. The sensor manifold is integral with the battery pack casting.

According to several aspects, a thermal runaway ducting system for a battery pack is provided. The thermal runaway ducting system may include one or more thermal runaway protection (TRP) trays. The thermal runaway ducting system further may include one or more flexible hoses in fluid communication with the one or more TRP trays using quick connect fittings. The thermal runaway ducting system further may include a sensor manifold in fluid communication with the one or more flexible hoses and a battery pack exit vent using quick connect fittings.

In another aspect of the present disclosure, each of the one or more TRP trays further includes an outlet spigot. The outlet spigot has a first portion disposed within one of the one or more TRP trays and a second portion disposed outside of one of the one or more TRP trays. The second portion is in fluid communication with the one or more flexible hoses.

In another aspect of the present disclosure, the thermal runaway ducting system of claim 13, the first portion of the outlet spigot further includes a solid particulate filter for preventing solid particles from entering the outlet spigot.

In another aspect of the present disclosure, the second portion of the outlet spigot further includes a quick connect fitting configured to engage with one of the one or more flexible hoses.

In another aspect of the present disclosure, the quick connect fitting is substantially perpendicular to one of the one or more TRP trays.

In another aspect of the present disclosure, each of the one or more TRP trays further includes a tray portion having a convex surface. Each of the one or more TRP trays further includes a lid portion having an interior lid surface. The lid portion is affixed to the tray portion such that a fluid collection cavity is formed between the interior lid surface of the lid portion and the convex surface of the tray portion. Each of the one or more TRP trays further includes one or more filtering fin members disposed on the interior lid surface of the lid portion. The one or more filtering fin members are configured to prevent solid particles from entering the outlet spigot.

According to several aspects, a thermal runaway ducting system for a battery pack is provided. The thermal runaway ducting system may include one or more thermal runaway protection (TRP) trays. Each of the one or more TRP trays has an outlet spigot. The outlet spigot has a first portion disposed within one of the one or more TRP trays and a second portion disposed outside of one of the one or more TRP trays. The second portion of the outlet spigot has a quick connect fitting. The thermal runaway ducting system further may include one or more flexible hoses in fluid communication with the outlet spigot of the one or more TRP trays. Each of the one or more flexible hoses has a first quick connect fitting and each of the one or more flexible hoses has a second quick connect fitting. The thermal runaway ducting system further may include a sensor manifold in fluid communication with the one or more flexible hoses and a battery pack exit vent. The sensor manifold has one or more inlet ports in fluid communication with one of the one or more flexible hoses. The sensor manifold has a sensor port configured to allow measurement of a fluid within the sensor manifold using a sensor. The sensor manifold has an outlet port in fluid communication with the battery pack exit vent.

In another aspect of the present disclosure, the one or more flexible hoses further includes a first flexible hose. The first quick connect fitting of the first flexible hose is in fluid communication with a first outlet spigot of a first TRP tray. The second quick connect fitting of the first flexible hose is in fluid communication with the sensor manifold. The one or more flexible hoses further may include a second flexible hose. The first quick connect fitting of the second flexible hose is in fluid communication with a second outlet of a second TRP tray. The second quick connect fitting of the second flexible hose is in fluid communication with the sensor manifold.

In another aspect of the present disclosure, the sensor manifold further includes a first inlet port in fluid communication with the second quick connect fitting of the first flexible hose. The sensor manifold further may include a second inlet port in fluid communication with the second quick connect fitting of the second flexible hose.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1A is a bottom view of a thermal runaway protection system, according to an exemplary embodiment;

FIG. 1B is a top view of a thermal runaway protection system, according to an exemplary embodiment;

FIG. 2A is a magnified view of a portion of the thermal runaway protection system of FIG. 1A showing a first exemplary embodiment of a thermal runaway ducting system, according to an exemplary embodiment;

FIG. 2B is a perspective magnified view of a portion of the top view of the thermal runaway protection system of FIG. 1B is shown, according to an exemplary embodiment;

FIG. 2C is a magnified view of a portion of the thermal runaway protection system of FIG. 1A showing a second exemplary embodiment of a thermal runaway ducting system, according to an exemplary embodiment;

FIG. 2D is a magnified view of a portion of the thermal runaway protection system of FIG. 1A showing a third exemplary embodiment of a thermal runaway ducting system, according to an exemplary embodiment;

FIG. 3 is a bottom perspective view of the thermal runaway protection system of FIG. 1A including a fourth exemplary embodiment of the thermal runaway ducting system, according to an exemplary embodiment;

FIG. 4A is a side view of a portion of the bottom perspective view of the thermal runaway protection system of FIG. 3 including a first outlet spigot, according to an exemplary embodiment;

FIG. 4B is a perspective view of a portion of the thermal runaway protection system shown in FIG. 3 including the sensor manifold, according to an exemplary embodiment;

FIG. 4C is a section (as indicated in FIG. 3) of a first TRP tray, according to an exemplary embodiment;

FIG. 5 is a bottom perspective view of a fifth exemplary embodiment of the thermal runaway ducting system, according to an exemplary embodiment; and

FIG. 6 is a schematic diagram of an exemplary vehicle shown with a battery pack including the thermal runaway protection system, according to an exemplary embodiment.

### DETAILED DESCRIPTION

The following description is merely exemplary in nature and is not intended to limit the present disclosure, application, or uses.

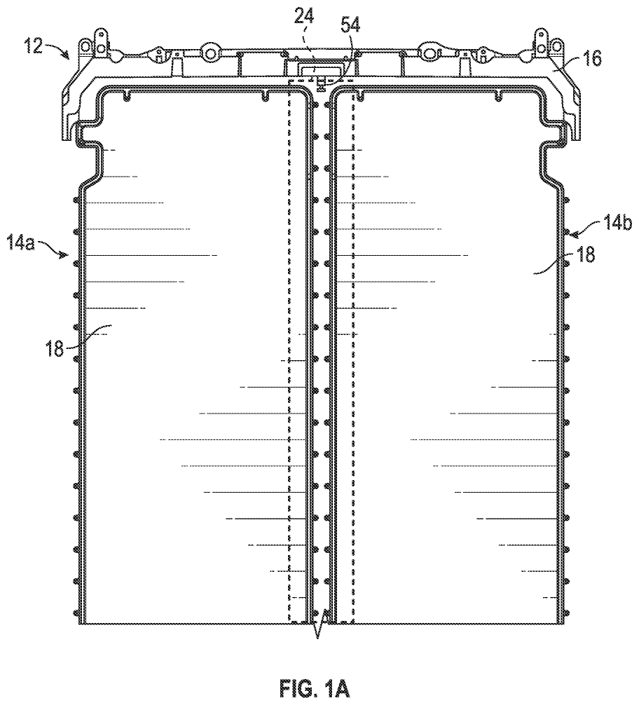

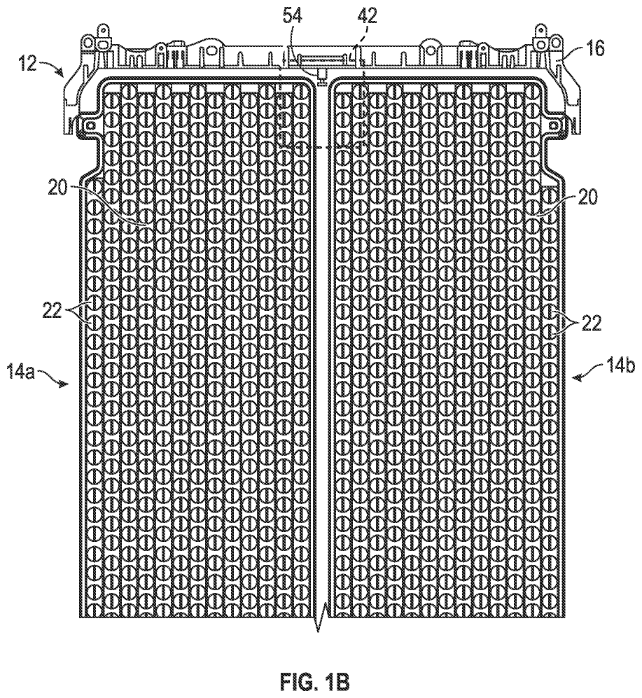

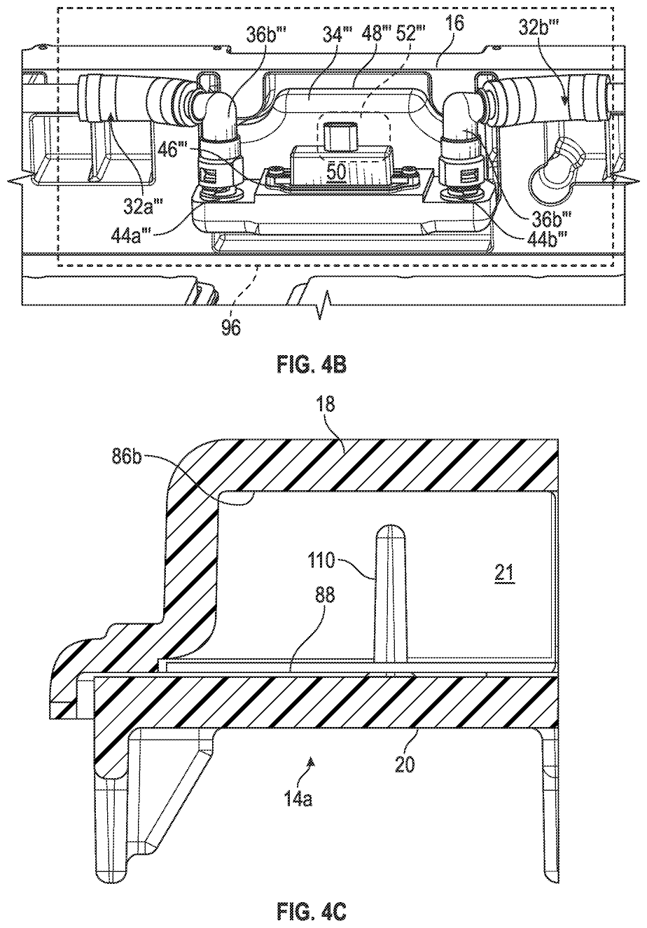

Referring to FIGS. 1A-1B, a bottom view of a thermal runaway protection system 12 is shown in FIG. 1A, and a top view of the thermal runaway protection system 12 is shown in FIG. 1B. The thermal runaway protection system 12 includes a first TRP tray 14a, a second TRP tray 14b, and a battery pack casting 16. The first and second TRP trays 14a, 14b are used to capture and direct fluid expelled from one or more electric battery cells (not shown) during a thermal runaway event. In the scope of the present disclosure, fluid expelled during a thermal runaway event may include liquids and/or gases (e.g., carbon dioxide, carbon monoxide, methane, hydrogen, ethylene, and/or the like). The fluid further may include solid particles (e.g., pieces of internal components of the one or more electric battery cells) suspended in the fluid. In an exemplary embodiment, the first and second TRP trays 14a, 14b include a tray portion 18 and a lid portion 20. The tray portion 18 and the lid portion 20 are affixed to each other to form a fluid collection cavity 21 (FIG. 4C), as will be discussed in greater detail below in reference to FIG. 4C. In an exemplary embodiment, the lid portion 20 includes one or more mica plates 22 (FIG. 1B). Each of the one or more electric battery cells (not shown) is disposed above one of the one or more mica plates 22. During a thermal runaway event, a pressure relief valve on one or more of the electric battery cells (not shown) releases, venting fluid out of the electric battery cell. The force of the venting fluid bursts the mica plate 22 disposed under the electric battery cell, allowing the fluid to vent into the fluid collection cavity 21 (FIG. 4C) of the TRP tray 14. It is advantageous to quickly and reliably expel fluid from the thermal runaway protection system 12 to mitigate the buildup of high-temperature fluid during a thermal runaway event. Accordingly, the present disclosure provides multiple embodiments of new and improved thermal runaway ducting systems and apparatuses for battery packs.

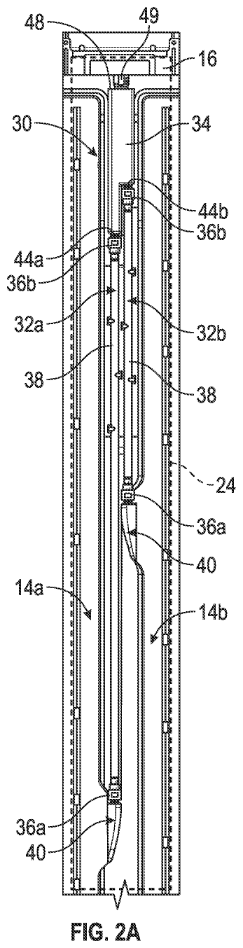

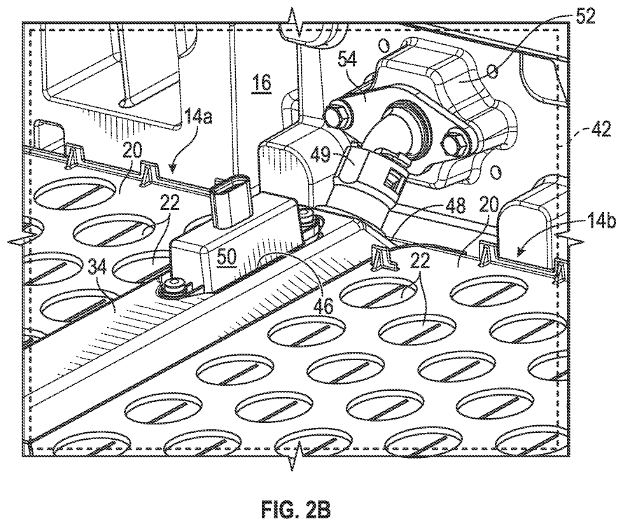

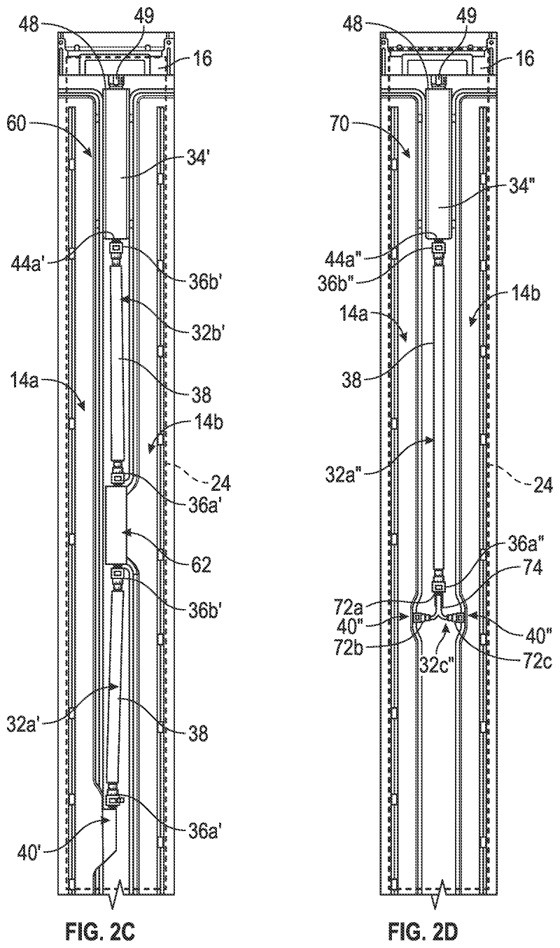

Referring to FIG. 2A and with continued reference to FIG. 1A, a magnified view of a portion 24 of the thermal runaway protection system 12 showing a first exemplary embodiment of a thermal runaway ducting system 30 is shown. The first exemplary embodiment of the thermal runaway ducting system 30 includes a first flexible hose 32a, a second flexible hose 32b, and a sensor manifold 34. Each of the flexible hoses 32a, 32b has a first quick connect fitting 36a, a second quick connect fitting 36b, and a flexible tube 38 in fluid communication with the first quick connect fitting 36a and the second quick connect fitting 36b.

In a non-limiting example, the first and second quick connect fittings 36a, 36b include one or more sealing members (e.g., O-rings, gaskets, and/or the like) and provide for a fluid-tight connection without screwing, welding, brazing, and/or the like. In a non-limiting example, the first and second quick connect fittings 36a, 36b are configured to provide verification of a successful connection, using, for example, a change in shape, size, position, orientation, or color of one or more components of the first and second quick connect fittings 36a, 36b. For example, SELFY Quick Connectors manufactured and/or distributed by ARAYMOND MOBILITY may be used as the first and second quick connect fittings 36a, 36b. In a non-limiting example, the flexible tube 38 is made from a thermoplastic of UL94 V1 or better rating. In another non-limiting example, the flexible tube 38 is made from metal. In a non-limiting example, an inner diameter of the flexible tube 38 is between 0.25 inches and 3 inches, inclusive.

In the first exemplary embodiment of the thermal runaway ducting system 30, the first quick connect fitting 36a of the first flexible hose 32a is in fluid communication with the first TRP tray 14a. In the first exemplary embodiment of the thermal runaway ducting system 30, the first TRP tray 14a includes a first outlet spigot 40. The first quick connect fitting 36a is removably connected with the first outlet spigot 40 of the first TRP tray 14a, establishing fluid communication with the first TRP tray 14a and allowing fluid in the first TRP tray 14a to be evacuated into the first flexible hose 32a. In a non-limiting example, the first outlet spigot 40 includes a quick connect fitting configured to engage with the first quick connect fitting 36a. The second quick connect fitting 36b of the first flexible hose 32a is in fluid communication with the sensor manifold 34, as will be discussed in greater detail below.

The first quick connect fitting 36a of the second flexible hose 32b is in fluid communication with the second TRP tray 14b. In the first exemplary embodiment of the thermal runaway ducting system 30, the second TRP tray 14b includes a first outlet spigot 40. The first quick connect fitting 36a of the second flexible hose 32b is removably connected with the first outlet spigot 40 of the second TRP tray 14b, establishing fluid communication with the second TRP tray 14b and allowing fluid in the second TRP tray 14b to be evacuated into the second flexible hose 32b. In a non-limiting example, the first outlet spigot 40 includes a quick connect fitting configured to engage with the first quick connect fitting 36a. The second quick connect fitting 36b of the second flexible hose 32b is in fluid communication with the sensor manifold 34, as will be discussed in greater detail below.

Referring to FIG. 2B, a perspective magnified view of a portion 42 of the top view of the thermal runaway protection system 12 of FIG. 1B is shown. With reference to FIG. 2B and continued reference to FIG. 2A, the sensor manifold 34 is used to receive fluid from the first and second TRP trays 14a, 14b. The sensor manifold 34 includes a first inlet port 44a, a second inlet port 44b, a sensor port 46, and an outlet port 48. The first and second inlet ports 44a, 44b are in fluid communication with first and second flexible hoses 32a, 32b. In the first exemplary embodiment of the thermal runaway ducting system 30, the first inlet port 44a is in fluid communication with the second quick connect fitting 36b of the first flexible hose 32a and the second inlet port 44b is in fluid communication with the second quick connect fitting 36b of the second flexible hose 32b. In a non-limiting example, the first and second inlet ports 44a, 44b include quick connect fittings configured to connect with the second quick connect fitting 36b of the first and second flexible hoses 32a, 32b.

The sensor port 46 (FIG. 2B) is configured to allow measurement of the fluid within the sensor manifold 34 using a sensor 50. In an exemplary embodiment, the sensor port 46 includes one or more sealing members (e.g., O-rings, gaskets, and/or the like) providing a fluid-tight seal between the sensor 50 and the sensor manifold 34. In an exemplary embodiment, the sensor 50 is used by a controller (not shown) to measure characteristics of a fluid within the sensor manifold 34. In a non-limiting example, the sensor 50 includes one or more of: a fluid type sensor, a fluid temperature sensor, a fluid flow rate sensor, and/or the like.

The outlet port 48 is used to expel fluid from the sensor manifold 34. The outlet port 48 is in fluid communication with a battery pack exit vent 52 (FIG. 2B) integral with the battery pack casting 16. In an exemplary embodiment, the outlet port 48 is in fluid communication with a sensor manifold exit spigot 54 (FIG. 2B) using a quick connect fitting 49. The sensor manifold exit spigot 54 is in fluid communication with the battery pack exit vent 52 using a press-in-place seal. In the scope of the present disclosure, a press-in-place seal includes a compressible material (e.g., rubber or silicone) disposed on a first mating surface (e.g., the sensor manifold exit spigot 54) configured to fit into a corresponding groove or channel on a second mating surface (e.g., the battery pack exit vent 52). In a non-limiting example, the press-in-place seal is installed by pressing the first mating surface against the second mating surface (e.g., using fasteners such as screws, bolts, rivets, or the like), such that the compressible material conforms to the shape of the first mating surface and the groove/channel of the second mating surface, forming a fluid-tight seal.

Referring to FIG. 2C and with continued reference to FIG. 1A, a magnified view of a portion 24 of the bottom view of the thermal runaway protection system 12 showing a second exemplary embodiment of the thermal runaway ducting system 60 is shown. The second exemplary embodiment of the thermal runaway ducting system 60 includes a first flexible hose 32a′, a second flexible hose 32b′, and a sensor manifold 34′. The description of the first and second flexible hoses 32a, 32b provided above in reference to the first exemplary embodiment of the thermal runaway ducting system 30 also applies to the first and second flexible hoses 32a′, 32b′ of the second exemplary embodiment of the thermal runaway ducting system 60.

In the second exemplary embodiment of the thermal runaway ducting system 60, the first quick connect fitting 36a′ of the first flexible hose 32a′ is in fluid communication with the first TRP tray 14a. In the second exemplary embodiment of the thermal runaway ducting system 60, the first TRP tray 14a includes a first outlet spigot 40′. The first quick connect fitting 36a′ of the first flexible hose 32a′ is removably connected with the first outlet spigot 40′ of the first TRP tray 14a, establishing fluid communication with the first TRP tray 14a and allowing fluid in the first TRP tray 14a to be evacuated into the first flexible hose 32a′. The description of the first outlet spigot 40 provided above in reference to the first exemplary embodiment of the thermal runaway ducting system 30 also applies to the first outlet spigot 40′ of the second exemplary embodiment of the thermal runaway ducting system 60. In a non-limiting example, the first outlet spigot 40′ includes a quick connect fitting configured to engage with the first quick connect fitting 36a′ of the first flexible hose 32a′. In the second exemplary embodiment of the thermal runaway ducting system 60, the second TRP tray 14b includes a second outlet spigot 62. In a non-limiting example, the second outlet spigot 62 includes two quick connect fittings. The second quick connect fitting 36b′ of the first flexible hose 32a′ is in fluid communication with the second outlet spigot 62 of the second TRP tray 14b.

The first quick connect fitting 36a′ of the second flexible hose 32b′ is in fluid communication with the second TRP tray 14b using the second outlet spigot 62 of the second TRP tray 14b, allowing fluid in the first TRP tray 14a and the second TRP tray 14b to be evacuated into the second flexible hose 32b′. In a non-limiting example, the second outlet spigot 62 includes two quick connect fittings configured to engage with the second quick connect fitting 36b′ of the first flexible hose 32a′ and the first quick connect fitting 36a′ of the second flexible hose 32b′. The second quick connect fitting 36b′ of the second flexible hose 32b′ is in fluid communication with the sensor manifold 34′, as will be discussed in greater detail below.

It should be understood that the second outlet spigot 62 of the second TRP tray 14b differs from the first outlet spigot 40′ in that the second outlet spigot 62 allows fluid communication between the first flexible hose 32a′, the second flexible hose 32b′, and the second TRP tray 14b. Therefore, in the second exemplary embodiment of the thermal runaway ducting system 60, fluid evacuated from the first TRP tray 14a may enter the second TRP tray 14b at the second outlet spigot 62.

The sensor manifold 34′ of the second exemplary embodiment of the thermal runaway ducting system 60 includes a first inlet port 44a′, the sensor port 46, and the outlet port 48 as described above in reference to the first exemplary embodiment of the thermal runaway ducting system 30. In the second exemplary embodiment of the thermal runaway ducting system 60, the first inlet port 44a′ is in fluid communication with the second quick connect fitting 36b′ of the second flexible hose 32b′. The description of the first inlet port 44a provided above in reference to the first exemplary embodiment of the thermal runaway ducting system 30 also applies to the first inlet port 44a′ of the second exemplary embodiment of the thermal runaway ducting system 60. The description of the sensor port 46 and the outlet port 48 provided above in reference to the sensor manifold 34 of the first exemplary embodiment of the thermal runaway ducting system 30 is also applicable to the sensor manifold 34′ of the second exemplary embodiment of the thermal runaway ducting system 60.

Referring to FIG. 2D and with continued reference to FIG. 1A, a magnified view of the portion 24 of the thermal runaway protection system 12 showing a third exemplary embodiment of the thermal runaway ducting system 70 is shown. The third exemplary embodiment of the thermal runaway ducting system 70 includes a first flexible hose 32a″, a tee-joint hose 32c″, and a sensor manifold 34″. The description of the first flexible hose 32a provided above in reference to the first exemplary embodiment of the thermal runaway ducting system 30, also applies to the first flexible hose 32a″ of the third exemplary embodiment of the thermal runaway ducting system 70. The tee-joint hose 32c″ includes a first quick connect fitting 72a, a second quick connect fitting 72b, a third quick connect fitting 72c, and a flexible tube 74. The first quick connect fitting 72a, second quick connect fitting 72b, and third quick connect fitting 72c are in fluid communication with each other via the flexible tube 74. In a non-limiting example, the flexible tube 74 is made from a thermoplastic of UL94 V1 or better rating. In another non-limiting example, the flexible tube 74 is made from metal. In a non-limiting example, an inner diameter of the flexible tube 74 is between 0.25 inches and 3 inches, inclusive.

In the third exemplary embodiment of the thermal runaway ducting system 70, the first quick connect fitting 36a″ of the first flexible hose 32a″ is in fluid communication the first quick connect fitting 72a of the tee-joint hose 32c″, allowing fluid in the tee-joint hose 32c″ to be evacuated into the first flexible hose 32a″. The second quick connect fitting 72b of the tee-joint hose 32c″ is in fluid communication with the first TRP tray 14a. In the third exemplary embodiment of the thermal runaway ducting system 70, the first TRP tray 14a includes a first outlet spigot 40″. The second quick connect fitting 72b of the tee-joint hose 32c″ is removably connected with the first outlet spigot 40″ of the first TRP tray 14a. The description of the first outlet spigot 40 provided above in reference to the first exemplary embodiment of the thermal runaway ducting system 30 also applies to the first outlet spigot 40″ of the third exemplary embodiment of the thermal runaway ducting system 70. In the third exemplary embodiment of the thermal runaway ducting system 70, the second TRP tray 14b includes a first outlet spigot 40″. The third quick connect fitting 72c of the tee-joint hose 32c″ is removably connected with the first outlet spigot 40″ of the second TRP tray 14b. Therefore, in the third exemplary embodiment of the thermal runaway ducting system 70, fluid evacuated from the first TRP tray 14a may enter the second TRP tray 14b at the tee-joint hose 32c″. Furthermore, in the third exemplary embodiment of the thermal runaway ducting system 70, fluid evacuated from the second TRP tray 14b may enter the first TRP tray 14a at the tee-joint hose 32c″.

The sensor manifold 34″ of the third exemplary embodiment of the thermal runaway ducting system 70 includes a first inlet port 44a″, the sensor port 46, and the outlet port 48 as described above in reference to the second exemplary embodiment of the thermal runaway ducting system 60. The description of the sensor manifold 34′ provided above in reference to the second exemplary embodiment of the thermal runaway ducting system 60 is also applicable to the sensor manifold 34″ of the third exemplary embodiment of the thermal runaway ducting system 70. The first inlet port 44a″ of the sensor manifold 34″ is in fluid communication with the second quick connect fitting 36b″ of the first flexible hose 32a″.

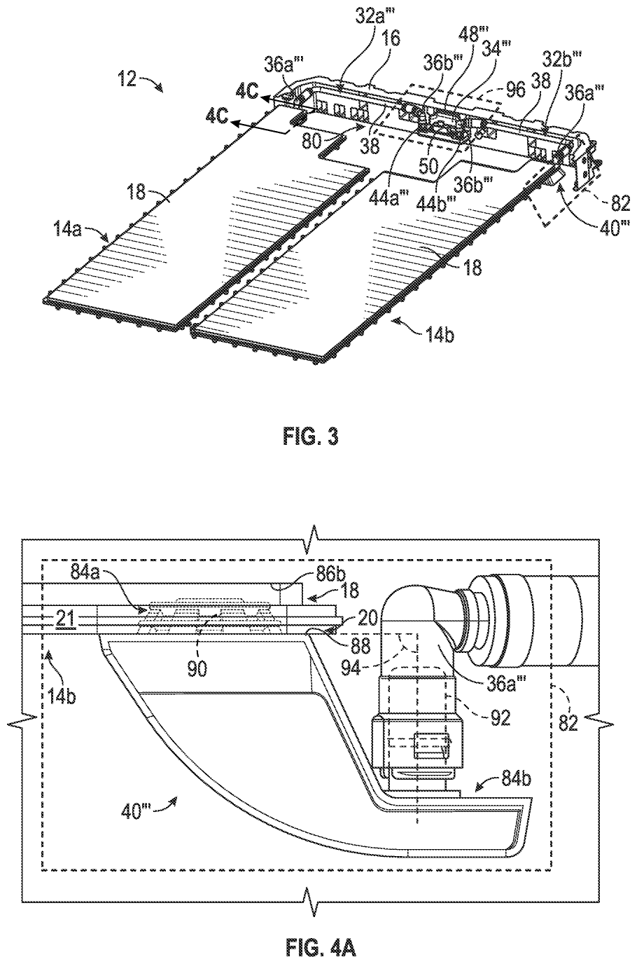

Referring to FIG. 3, a bottom perspective view of the thermal runaway protection system 12 including a fourth exemplary embodiment of the thermal runaway ducting system 80 is shown. The fourth exemplary embodiment of the thermal runaway ducting system 80 includes a first flexible hose 32a′″, a second flexible hose 32b′″, and a sensor manifold 34′″. The description of the first and second flexible hoses 32a, 32b provided above in reference to the first exemplary embodiment of the thermal runaway ducting system 30 also applies to the first and second flexible hoses 32a′″, 32b′″ of the fourth exemplary embodiment of the thermal runaway ducting system 80.

In the fourth exemplary embodiment of the thermal runaway ducting system 80, the first quick connect fitting 36a′″ of the first flexible hose 32a′″ is in fluid communication with the first TRP tray 14a. In the fourth exemplary embodiment of the thermal runaway ducting system 80, the first TRP tray 14a includes a first outlet spigot 40′″. The first quick connect fitting 36a′″ of the first flexible hose 32a′″ is removably connected with the first outlet spigot 40′″ of the first TRP tray 14a, allowing fluid in the first TRP tray 14a to be evacuated into the first flexible hose 32a′″. The second quick connect fitting 36b′″ of the first flexible hose 32a′″ is in fluid communication with the sensor manifold 34″, as will be discussed in greater detail below. The first quick connect fitting 36a′″ of the second flexible hose 32b′″ is in fluid communication with the second TRP tray 14b. In the fourth exemplary embodiment of the thermal runaway ducting system 80, the second TRP tray 14b includes a first outlet spigot 40′″. The first quick connect fitting 36a′″ of the second flexible hose 32b′″ is removably connected with the first outlet spigot 40′″ of the second TRP tray 14b, allowing fluid in the second TRP tray 14b to be evacuated into the second flexible hose 32b′″. The second quick connect fitting 36b′″ of the second flexible hose 32b′″ is in fluid communication with the sensor manifold 34′″, as will be discussed in greater detail below.

Referring to FIG. 4A, a side view of a portion 82 of the bottom perspective view of the thermal runaway protection system 12 of FIG. 3 including the first outlet spigot 40′″ is shown. The first outlet spigot 40′″ has a first portion 84a and a second portion 84b. The first portion 84a is in fluid communication with the second portion 84b with a hollow internal cavity. The first portion 84a is disposed within the fluid collection cavity 21 formed between a convex surface 86b of the tray portion 18 of the first and second TRP trays 14a, 14b and an interior lid surface 88 of the lid portion 20 of the first and second TRP trays 14a, 14b. In an exemplary embodiment, the first portion 84a of the first outlet spigot 40′″ includes a solid particulate filter 90 for preventing solid particles from entering the outlet spigot 40′″. In a non-limiting example, the solid particulate filter 90 is a sieve-like structure including one or more holes allowing fluid to pass through. Each of the one or more holes are configured with an area less than or equal to a predetermined maximum particle cross-sectional area. The predetermined maximum particle cross-sectional area defines a cross-sectional area of a largest particle which is permitted to enter the first outlet spigot 40′″. In another exemplary embodiment, the first portion 84a of the first outlet spigot 40′″ further includes one or more angled particle deflection surfaces (not shown) disposed proximally to the solid particulate filter 90 for deflecting solid particles away from the solid particulate filter 90.

In an exemplary embodiment, the second portion 84b of the first outlet spigot 40′″ includes a quick connect fitting 92 configured to engage with the first quick connect fitting 36a′″. In a non-limiting example, as shown in FIG. 4A, the quick connect fitting 92 is substantially perpendicular to the first and second TRP trays 14a, 14b. In the scope of the present disclosure, substantially perpendicular means that an angle 94 measured between the quick connect fitting 92 and the first and second TRP trays 14a, 14b is approximately ninety degrees within a predetermined tolerance (e.g., ±10%).

Referring again to FIG. 3, in the fourth exemplary embodiment of the thermal runaway ducting system 80, the first outlet spigot 40′″ is disposed proximally to an outside edge of each of the first and second TRP trays 14a, 14b, allowing for improved ergonomic access for connection of the first quick connect fitting 36a′″ of the first flexible hose 32a′″ and the first quick connect fitting 36a′″ of the second flexible hose 32b′″ during assembly of the thermal runaway protection system 12.

Referring to FIG. 4B, a perspective view of a portion 96 of the thermal runaway protection system 12 shown in FIG. 3 including the sensor manifold 34′″ is shown. The sensor manifold 34′″ of the fourth exemplary embodiment of the thermal runaway ducting system 80 includes a first inlet port 44a′″, a second inlet port 44b′″, a sensor port 46′″, and an outlet port 48′″. In the fourth exemplary embodiment of the thermal runaway ducting system 80, the first inlet port 44a′″ is in fluid communication with the second quick connect fitting 36b′″ of the first flexible hose 32a′″. The second inlet port 44b′″ is in fluid communication with the second quick connect fitting 36b′″ of the second flexible hose 32b′″. In a non-limiting example, the first and second inlet ports 44a′″, 44b′″ include quick connect fittings configured to connect with the second quick connect fitting 36b′″ of the first and second flexible hoses 32a′″, 32b′″.

The sensor port 46′″ is configured to allow measurement of the fluid within the sensor manifold 34′″ using the sensor 50, as discussed above. In an exemplary embodiment, the sensor port 46′″ includes one or more sealing members (e.g., O-rings, gaskets, and/or the like) providing a fluid-tight seal between the sensor 50 and the sensor manifold 34′″. In an exemplary embodiment, the sensor 50 is used by a controller (not shown) to measure characteristics of a fluid within the sensor manifold 34′″. In a non-limiting example, the sensor 50 includes one or more of: a fluid type sensor, a fluid temperature sensor, a fluid flow rate sensor, and/or the like.

The outlet port 48′″ is used to expel fluid from the sensor manifold 34′″. In the fourth exemplary embodiment of the thermal runaway ducting system 80, the outlet port 48′″ is in fluid communication with a battery pack exit vent 52′″ integral with the battery pack casting 16. In an exemplary embodiment, the outlet port 48′″ is in fluid communication with the battery pack exit vent 52′″ using a press-in-place seal between the sensor manifold 34′″ and the battery pack casting 16. In the scope of the present disclosure, a press-in-place seal includes a compressible material (e.g., rubber or silicone) disposed on a first mating surface (e.g., the sensor manifold 34′″) configured to fit into a corresponding groove or channel on a second mating surface (e.g., the battery pack casting 16). In a non-limiting example, the press-in-place seal is installed by pressing the first mating surface against the second mating surface (e.g., using fasteners such as screws, bolts, rivets, or the like), such that the compressible material conforms to the shape of the first mating surface and the groove/channel of the second mating surface, forming a fluid-tight seal.

Referring to FIG. 4C, a section (as indicated in FIG. 3) of the first TRP tray 14a is shown. In an exemplary embodiment, the first and second TRP trays 14a, 14b further include one or more filtering fin members 110 disposed on the interior lid surface 88 of the lid portion 20 and extending into the fluid collection cavity 21. The one or more filtering fin members 110 function to disrupt a flow of solid particles within the fluid collection cavity 21 in order to prevent the solid particles from entering the outlet spigot 40′″. In an exemplary embodiment, the first and second TRP trays 14a, 14b include a plurality of filtering fin members 110 distributed throughout the first and second TRP trays 14a, 14b. In another exemplary embodiment, the first and second TRP trays 14a, 14b include a plurality of filtering fin members 110 disposed proximally to the outlet spigot 40′″. In a non-limiting example, the plurality of filtering fin members 110 are disposed proximally to the outlet spigot 40′″ in a radial or “U-shaped” pattern to induce a swirling motion in the fluid. The swirling motion causes solid particles to impact the plurality of filtering fin members 110, exiting the fluid flow.

In a non-limiting example, the one or more filtering fin members 110 are made of a same material as the lid portion 20 (e.g., plastic, polymer, metal, composite, and/or the like). It should be understood that the one or more filtering fin members 110 may be used with any of the embodiments of the thermal runaway ducting system discussed in the present disclosure.

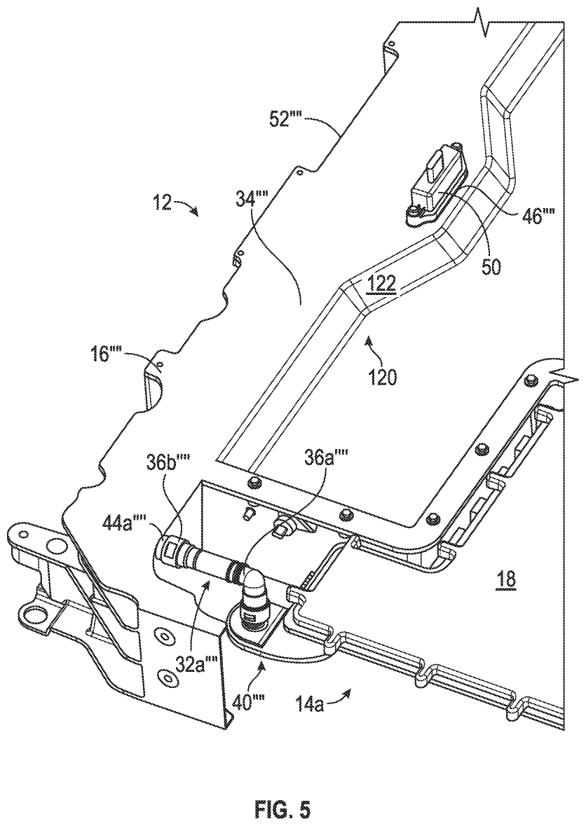

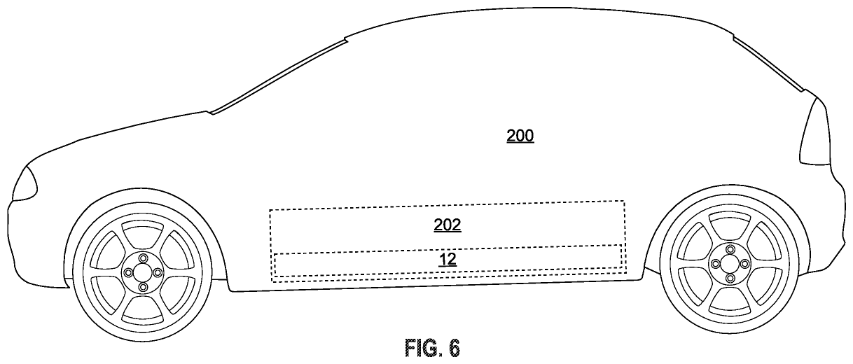

Referring to FIG. 5, a bottom perspective view of a fifth exemplary embodiment of the thermal runaway ducting system 120 is shown. The fifth exemplary embodiment of the thermal runaway ducting system 120 includes a first flexible hose 32a″″, a second flexible hose (not shown) and a sensor manifold 34″″. The description of the first flexible hose 32a″″ provided above in reference to the first exemplary embodiment of the thermal runaway ducting system 30 also applies to the first flexible hose 32a″″ of the fifth exemplary embodiment of the thermal runaway ducting system 120.

In the fifth exemplary embodiment of the thermal runaway ducting system 120, the first quick connect fitting 36a″″ of the first flexible hose 32a″″ is in fluid communication with the first TRP tray 14a. In the fifth exemplary embodiment of the thermal runaway ducting system 120, the first TRP tray 14a includes a first outlet spigot 40″″. The first quick connect fitting 36a″″ of the first flexible hose 32a″″ is removably connected to the first outlet spigot 40″″ of the first TRP tray 14a, allowing fluid in the first TRP tray 14a to be evacuated into the first flexible hose 32a″″. The description of the first outlet spigot 40′″ provided above in reference to the fourth exemplary embodiment of the thermal runaway ducting system 80 also applies to the first outlet spigot 40″″ of the fifth exemplary embodiment of the thermal runaway ducting system 120. The second quick connect fitting 36b″″ of the first flexible hose 32a″″ is in fluid communication with the sensor manifold 34″″, as will be discussed in greater detail below. In the fifth exemplary embodiment of the thermal runaway ducting system 120, the second TRP tray 14b (not shown in FIG. 5) includes a first outlet spigot (not shown). The first quick connect fitting (not shown) of the second flexible hose (not shown) is removably connected to the first outlet spigot (not shown) of the second TRP tray 14b, allowing fluid in the second TRP tray 14b to be evacuated into the second flexible hose (not shown). The second quick connect fitting (not shown) of the second flexible hose (not shown) is in fluid communication with the sensor manifold 34″″, as will be discussed in greater detail below.

In the fifth exemplary embodiment of the thermal runaway ducting system 120, the sensor manifold 34″″ is integral with a battery pack casting 16″″. In the scope of the present disclosure, integral with means that multiple parts are combined as a single structure. The battery pack casting 16″″ includes a first inlet port 44a″″ and a second inlet port (not shown) for connection with the first flexible hose 32a″″ and the second flexible hose (not shown). The battery pack casting 16″″ further includes a hollow cavity 122 for containing fluids evacuated from the first flexible hose 32a″″ and the second flexible hose (not shown). The battery pack casting 16″″ further includes a sensor port 46″″ for receiving the sensor 50. The battery pack casting 16″″ further includes a battery pack exit vent 52″″ for expelling fluids from the thermal runaway protection system 12. The second quick connect fitting 36b″″ of the first flexible hose 32a″″ is in fluid communication with the first inlet port 44a″″. The second quick connect fitting (not shown) of the second flexible hose (not shown) is in fluid communication with the second inlet port (not shown). It should be understood that embodiments where the sensor manifold 34″″ is integral with the battery pack casting 16″″, as discussed in reference to the fifth exemplary embodiment of the thermal runaway ducting system 120, may be used with any of the embodiments of the thermal runaway ducting system discussed in the present disclosure.

Referring to FIG. 6, schematic diagram of an exemplary vehicle 200 is shown with a battery pack 202 including the thermal runaway protection system 12. While a passenger vehicle is illustrated, it should be appreciated that the vehicle 200 may be any type of vehicle without departing from the scope of the present disclosure. In an exemplary embodiment, the battery pack 202 including the thermal runaway protection system 12 is disposed on an underside of the vehicle 200.

The embodiments of the thermal runaway ducting system discussed in the present disclosure offer several advantages. Use of the quick connect fittings allows for verifiable connection of the components. Furthermore, the ducting system may be pressure and/or leak tested after assembly to ensure fluid-tight construction. The embodiments of the thermal runaway ducting system discussed in the present disclosure are robust to intrusion of potting material which may be used within the thermal runaway protection system 12, ensuring that fluid venting paths remain unobstructed. Additionally, the use of the solid particulate filter and/or the one or more filtering fin members prevents entry of solid particles into the fluid venting paths. Furthermore, the flexible hoses provide for ease of assembly and mitigate clearance issues due to manufacturing variation. Additionally, orientation of the quick connect fittings substantially perpendicular to the one or more TRP trays enables line of sight for robotic assembly of the thermal runaway protection system 12.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A thermal runaway ducting system for a battery pack having one or more thermal runaway protection (TRP) trays, the thermal runaway ducting system comprising:
one or more flexible hoses in fluid communication with the one or more TRP trays; and
a sensor manifold in fluid communication with the one or more flexible hoses and a battery pack exit vent.

2. The thermal runaway ducting system of claim 1, each of the one or more flexible hoses further comprising:
a first quick connect fitting;
a second quick connect fitting; and
a flexible tube in fluid communication with the first quick connect fitting and the second quick connect fitting, wherein the flexible tube provides fluid communication between the first quick connect fitting and the second quick connect fitting.

3. The thermal runaway ducting system of claim 2, the one or more flexible hoses further comprising:
a first flexible hose, wherein the first quick connect fitting of the first flexible hose is in fluid communication with a first TRP tray, and wherein the second quick connect fitting of the first flexible hose is in fluid communication with the sensor manifold; and
a second flexible hose, wherein the first quick connect fitting of the second flexible hose is in fluid communication with a second TRP tray, and wherein the second quick connect fitting of the second flexible hose is in fluid communication with the sensor manifold.

4. The thermal runaway ducting system of claim 3, the sensor manifold further comprising:
a first inlet port in fluid communication with the second quick connect fitting of the first flexible hose; and
a second inlet port in fluid communication with the second quick connect fitting of the second flexible hose.

5. The thermal runaway ducting system of claim 2, the one or more flexible hoses further comprising:
a first flexible hose, wherein the first quick connect fitting of the first flexible hose is in fluid communication with a first TRP tray, and wherein the second quick connect fitting of the first flexible hose is in fluid communication with a second TRP tray; and
a second flexible hose, wherein the first quick connect fitting of the second flexible hose is in fluid communication with the second TRP tray, and wherein the second quick connect fitting of the second flexible hose is in fluid communication with the sensor manifold.

6. The thermal runaway ducting system of claim 5, the sensor manifold further comprising:
a first inlet port in fluid communication with the second quick connect fitting of the second flexible hose.

7. The thermal runaway ducting system of claim 2, the one or more flexible hoses further comprising:
a tee-joint hose in fluid communication with a first TRP tray and a second TRP tray; and
a first flexible hose, wherein the first quick connect fitting of the first flexible hose is in fluid communication with the tee-joint hose, and wherein the second quick connect fitting of the first flexible hose is in fluid communication with the sensor manifold.

8. The thermal runaway ducting system of claim 7, the sensor manifold further comprising:
a first inlet port in fluid communication with the second quick connect fitting of the first flexible hose.

9. The thermal runaway ducting system of claim 1, the sensor manifold further comprising:
one or more inlet ports in fluid communication with one of the one or more flexible hoses;
a sensor port configured to allow measurement of a fluid within the sensor manifold using a sensor; and
an outlet port in fluid communication with the battery pack exit vent.

10. The thermal runaway ducting system of claim 9, the thermal runaway ducting system further comprising:
a battery pack casting, wherein the battery pack exit vent is integral with the battery pack casting, and wherein the outlet port of the sensor manifold is in fluid communication with the battery pack exit vent using a press-in-place seal.

11. The thermal runaway ducting system of claim 9, the thermal runaway ducting system further comprising:
a battery pack casting, wherein the battery pack exit vent is integral with the battery pack casting, and wherein the sensor manifold is integral with the battery pack casting.

12. A thermal runaway ducting system for a battery pack, the thermal runaway ducting system comprising:
one or more thermal runaway protection (TRP) trays;
one or more flexible hoses in fluid communication with the one or more TRP trays using quick connect fittings; and
a sensor manifold in fluid communication with the one or more flexible hoses and a battery pack exit vent using quick connect fittings.

13. The thermal runaway ducting system of claim 12, each of the one or more TRP trays further comprising:
an outlet spigot, wherein the outlet spigot has a first portion disposed within one of the one or more TRP trays and a second portion disposed outside of one of the one or more TRP trays, and wherein the second portion is in fluid communication with the one or more flexible hoses.

14. The thermal runaway ducting system of claim 13, the first portion of the outlet spigot further comprising:
a solid particulate filter for preventing solid particles from entering the outlet spigot.

15. The thermal runaway ducting system of claim 13, the second portion of the outlet spigot further comprising:
a quick connect fitting configured to engage with one of the one or more flexible hoses.

16. The thermal runaway ducting system of claim 15, wherein the quick connect fitting is substantially perpendicular to one of the one or more TRP trays.

17. The thermal runaway ducting system of claim 13, each of the one or more TRP trays further comprising:
a tray portion having a convex surface;
a lid portion having an interior lid surface, wherein the lid portion is affixed to the tray portion such that a fluid collection cavity is formed between the interior lid surface of the lid portion and the convex surface of the tray portion; and
one or more filtering fin members disposed on the interior lid surface of the lid portion, wherein the one or more filtering fin members are configured to prevent solid particles from entering the outlet spigot.

18. A thermal runaway ducting system for a battery pack, the thermal runaway ducting system comprising:
one or more thermal runaway protection (TRP) trays, wherein each of the one or more TRP trays has an outlet spigot, wherein the outlet spigot has a first portion disposed within one of the one or more TRP trays and a second portion disposed outside of one of the one or more TRP trays, and wherein the second portion of the outlet spigot has a quick connect fitting;
one or more flexible hoses in fluid communication with the outlet spigot of the one or more TRP trays, wherein each of the one or more flexible hoses has a first quick connect fitting, and wherein each of the one or more flexible hoses has a second quick connect fitting; and
a sensor manifold in fluid communication with the one or more flexible hoses and a battery pack exit vent, wherein the sensor manifold has one or more inlet ports in fluid communication with one of the one or more flexible hoses, wherein the sensor manifold has a sensor port configured to allow measurement of a fluid within the sensor manifold using a sensor, and wherein the sensor manifold has an outlet port in fluid communication with the battery pack exit vent.

19. The thermal runaway ducting system of claim 18, the one or more flexible hoses further comprising:
a first flexible hose, wherein the first quick connect fitting of the first flexible hose is in fluid communication with a first outlet spigot of a first TRP tray, and wherein the second quick connect fitting of the first flexible hose is in fluid communication with the sensor manifold; and
a second flexible hose, wherein the first quick connect fitting of the second flexible hose is in fluid communication with a second outlet of a second TRP tray, and wherein the second quick connect fitting of the second flexible hose is in fluid communication with the sensor manifold.

20. The thermal runaway ducting system of claim 19, the sensor manifold further comprising:
a first inlet port in fluid communication with the second quick connect fitting of the first flexible hose; and
a second inlet port in fluid communication with the second quick connect fitting of the second flexible hose.
